(19) United States
(12) Patent Application Publication
(10) Pub. No.: US 2024/0069210 A1
(43) Pub. Date: Feb. 29, 2024

(54) POSITIONING DEVICE, POSITIONING METHOD, AND POSITIONING PROGRAM

(71) Applicant: FURUNO ELECTRIC CO., LTD., Hyogo (JP)

(72) Inventor: Masaaki ENDO, Nishinomiya (JP)

(73) Assignee: FURUNO ELECTRIC CO., LTD., Hyogo (JP)

(21) Appl. No.: 18/502,511

(22) Filed: Nov. 6, 2023

Related U.S. Application Data
(63) Continuation-in-part of application No. PCT/JP2022/008558, filed on Mar. 1, 2022.

(30) Foreign Application Priority Data
May 6, 2021 (JP) 2021-078676

(51) Int. Cl. G01S 19/29

(52) U.S. Cl. CPC G01S 19/29

(57) ABSTRACT

A time until highly accurate position measurement starts is estimated. The positioning device includes processing circuitry configured to perform position measurement using carrier phases of a plurality of position measurement signals to calculate a position measurement result and an accuracy index of the position measurement result. The processing circuitry estimates the predicted convergence time of the position measurement based on the accuracy index.

### CROSS-REFERENCE TO RELATED APPLICATION

This application is a continuation application of PCT International Application No. PCT/JP2022/008558, which was filed on Mar. 1, 2022, and which claims priority to Japanese Patent Application No. JP2021-078676 filed on May 6, 2021, the entire disclosures of each of which are herein incorporated by reference for all purposes.

### BACKGROUND

### Technical Field

The present disclosure relates to a technique for performing position measurement using carrier phases of a position measurement signal.

### Background

Patent Literature 1 discloses a position measurement technique using carrier phases.
Patent Literature 1: Japanese Patent Application Laid-Open No. 2014-206502

### SUMMARY

However, in a conventional device configured to perform position measurement using carrier phases, it is not possible to know the time until highly accurate position measurement starts, in other words, the time until the ambiguity of the position measurement converges.

Therefore, an objective of the present disclosure is to estimate a time until highly accurate position measurement starts.

### BRIEF DESCRIPTION

A positioning device of the present disclosure includes processing circuitry configured to perform position measurement using the carrier phases of the plurality of position measurement signals to calculate a position measurement result and an accuracy index of the position measurement result. The processing circuitry estimates a convergence prediction time of the position measurement based on the accuracy index.

In this configuration, by utilizing the fact that the accuracy of the position measurement increases as the convergence approaches, the convergence prediction time of the position measurement is accurately estimated.

According to the present disclosure, it is possible to estimate a time until highly accurate position measurement starts.

### BRIEF DESCRIPTION OF DRAWINGS

The accompanying drawings are included to provide a further understanding of the present disclosure and are incorporated in and constitute a part of this specification. The drawings illustrate an exemplary embodiment of the present disclosure and, together with the description, serve to explain the principles of the present disclosure. It should be noted that in the accompanying drawings, like or same reference numerals refer to identical or functionally-similar elements throughout the separate views and which are incorporated in and form a part of the specification, further illustrate the disclosed embodiments and, together with the detailed description of the disclosure, serve to explain the principles of the disclosed embodiments.

### BRIEF DESCRIPTION OF THE DRAWINGS

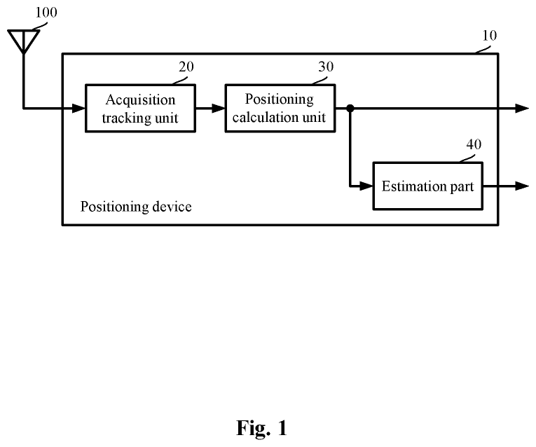

FIG. 1 is a functional block diagram of a positioning device according to an embodiment of the present disclosure.

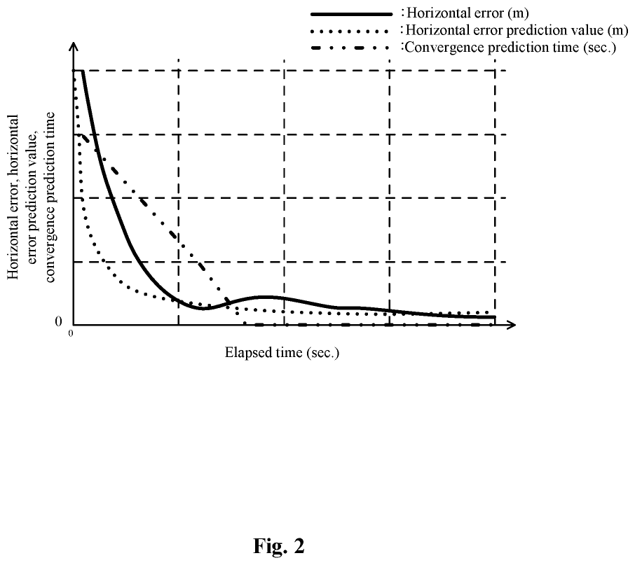

FIG. 2 is a graph illustrating an example of a time transition of a horizontal error, a horizontal error prediction value, and a convergence prediction time in an estimation calculation of position measurement.

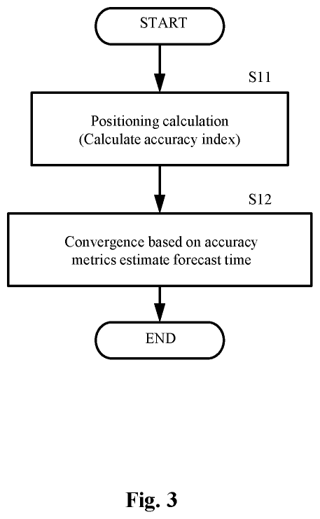

FIG. 3 is a flowchart illustrating a method of estimating a convergence prediction time of a position measurement according to an embodiment of the present disclosure.

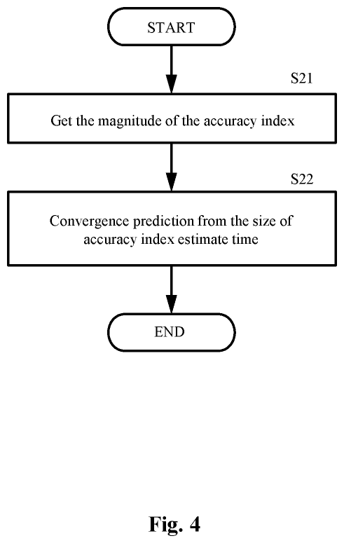

FIG. 4 is a flowchart illustrating a first aspect of estimation of a convergence prediction time based on an accuracy index.

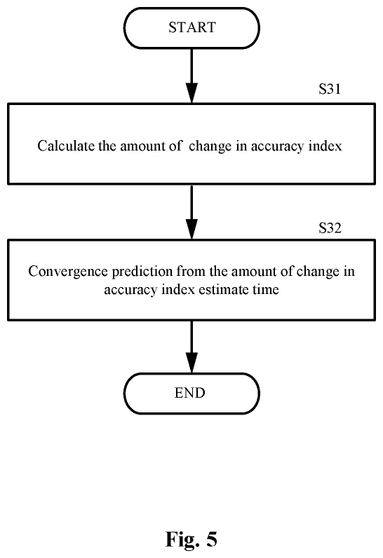

FIG. 5 is a flowchart illustrating a second mode of estimation of a convergence prediction time based on an accuracy index.

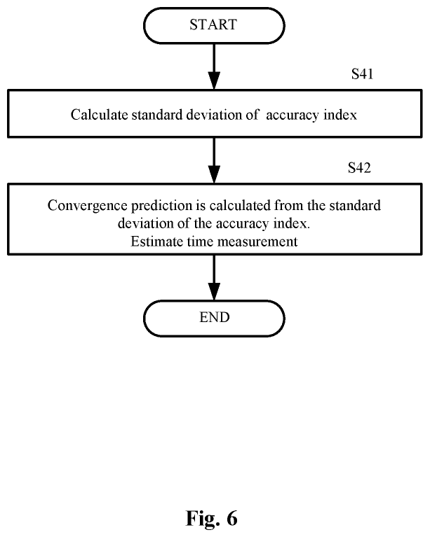

FIG. 6 is a flowchart illustrating a third aspect of estimation of a convergence prediction time based on an accuracy index.

Embodiments of the present disclosure will now be described with reference to the accompanying drawings.

### DETAILED DESCRIPTION

A position measurement technique according to an embodiment of the present disclosure will be described with reference to the drawings. FIG. 1 is a functional block diagram of a positioning device according to an embodiment of the present disclosure.

As illustrated in FIG. 1, the positioning device 10 includes processing circuitry configured to function as an acquisition and tracking module 20, as a position measurement module 30, and as an estimation module 40. The positioning device 10 is realized by, for example, an arithmetic processing device such as a predetermined electronic circuit or a CPU, a program (a non-transitory computer-readable storage medium having stored thereon machine-readable instructions that, when executed by one or more processors of an apparatus, cause the apparatus to perform a method) in which processing executed by the positioning device 10 is described, and a storage medium that stores the program.

An antenna 100 is connected to the positioning device 10. The antenna 100 receives position measurement signals from a plurality of positioning satellites (GNSS: Global Navigation Satellite System). The antenna 100 outputs the received position measurement signal to the acquisition and tracking module 20.

The acquisition and tracking module 20 includes a correlation processing module. The acquisition and tracking module 20 has the same configuration as that of the positioning device already filed by the applicant. Therefore, the description of the specific configuration and processing of the acquisition and tracking module 20 will be omitted.

The acquisition and tracking module 20 generates replica signals for a plurality of position measurement signals and performs correlation processing with the received position measurement signals. At this time, the acquisition and tracking module 20 calculates a code phase measurement value and carrier phases measurement value. The code phase measurement value is a phase difference between the code of the received position measurement signal and the code of the replica signal, and the carrier phases measurement value is a phase difference between the carrier of the received position measurement signal and the carrier of the replica code. The acquisition and tracking module 20 sequentially performs correlation processing and sequentially outputs the code phase measurement value and the carrier phases measurement value to the position measurement module 30.

The position measurement module 30 sets a state estimation equation in which carrier phases measurement value of a plurality of position measurement signals are used as an observation value, and the position of the positioning device 10, the clock error, and the carrier ambiguity are used as an estimation values. The carrier ambiguity includes “real value bias” and “integer value bias”. The state estimation equation is, for example, a Kalman filter.

The position measurement module 30 estimates the position, the clock error, and the carrier ambiguity as the estimation calculation of the position measurement using the state estimation equation. At this time, the position measurement module 30 calculates the accuracy index of the estimation calculation during the estimation calculation. For example, in the case of the above-described Kalman filter, the accuracy index is an error covariance matrix used in the Kalman filter.

By using the carrier phases measurement value for the estimation calculation of position measurement, the position measurement module 30 can estimate the position measurement result (For example, the position of the positioning device 10.) with higher accuracy than by using the code phase. However, since the position measurement using the carrier phases measurement value includes, for example, the carrier ambiguity, the position measurement has the ambiguity at the initial stage of the start of the position measurement. In the period having this ambiguity, the estimation accuracy is not high.

Therefore, the estimation calculation using the carrier phases measurement value takes time until the highly accurate position measurement starts, but after the carrier ambiguity is determined and the position measurement converges, the highly accurate position measurement can be continuously executed.

Therefore, the position measurement module 30 detects convergence of the position measurement based on the accuracy index. For example, when the accuracy index is an error covariance matrix, the error of the estimation calculation result increases as the accuracy index increases.

Therefore, in such a case, the position measurement module 30 sets a threshold for convergence detection for the accuracy index. The threshold value for convergence detection is set by, for example, the upper limit value of the accuracy index when the estimation calculation result falls within a predetermined error range according to the specification of the positioning device 10. When detecting that the accuracy index is equal to or less than the threshold for convergence detection, the position measurement module 30 detects that the position measurement has converged.

Then, for example, the position measurement module 30 does not output the estimation calculation result of the position measurement until the convergence of the position measurement is detected, and outputs the estimation calculation result of the position measurement when the convergence of the position measurement is detected. For example, when detecting the convergence of the position measurement, the position measurement module 30 outputs at least the position of the positioning device 10 in the estimation calculation result of the position measurement to, for example, a display or the like.

The position measurement module 30 sequentially outputs the accuracy index to the estimation module 40 during the estimation calculation of the position measurement described above.

The estimation module 40 estimates the predicted convergence time of the position measurement based on the accuracy index.

FIG. 2 is a graph illustrating an example of a time transition of a horizontal error, a horizontal error prediction value, and a convergence prediction time in an estimation calculation of position measurement. The convergence prediction time means the remaining time from that time point until convergence of the estimation calculation is detected. In FIG. 2, the vertical axis represents a horizontal error, a horizontal error prediction value, and a convergence prediction time, and the horizontal axis represents an elapsed time from the start of position measurement. In the vertical axis of FIG. 2, the horizontal error, the horizontal error prediction value, and the convergence prediction time have different scales and units, but are set on the same vertical axis for convenience of illustration.

As illustrated in FIG. 2, the horizontal error and the horizontal error prediction value gradually decrease as the estimation calculation of the position measurement progresses (as time elapses). That is, the accuracy of the estimation calculation result of the position measurement is improved as time elapses. Therefore, the convergence prediction time becomes shorter as the time from the start of position measurement elapses.

Then, the horizontal error prediction value only decreases as time elapses, and the convergence prediction time also decreases in accordance with the decrease in the horizontal error prediction value. That is, the horizontal error prediction value and the convergence prediction time have a one-to-one relationship, and the convergence prediction time can be estimated by using the horizontal error prediction value.

Here, the horizontal error prediction value is based on the accuracy index. For example, when the above-described Kalman filter is used, the horizontal error prediction value is obtained from the error covariance matrix. The horizontal error prediction value and the value of the error covariance matrix have a one-to-one relationship.

Therefore, the convergence prediction time can be estimated by using an accuracy index such as an error covariance matrix.

Using this, the estimation module 40 stores the relationship between the accuracy index and the convergence prediction time in a database or stores a calculation formula for calculating the convergence prediction time using the accuracy index. When the accuracy index is input, the estimation module 40 estimates the convergence prediction time using the database or the calculation formula. More specifically, the estimation module 40 estimates the convergence prediction time using the database or the calculation formula such that the convergence prediction time becomes shorter as the accuracy index becomes smaller, in other words, such that the convergence prediction time becomes longer as the accuracy index becomes larger.

By performing such processing, the estimation module 40 can accurately estimate and output the predicted convergence time of the position measurement, in other words, the time until the start of highly accurate position measurement.

As described above, by using the configuration and the processing of the present embodiment, the positioning device 10 can accurately estimate and output the time (convergence prediction time) until the start of highly accurate position measurement while performing highly accurate position measurement.

(Estimation Method of Convergence Prediction Time)

FIG. 3 is a flowchart illustrating a method of estimating a convergence prediction time of a position measurement according to an embodiment of the present disclosure. Note that the specific contents of each process described in the flow of FIG. 3 are described in the description of the above-described configuration and process, and the description thereof will be omitted below except for a portion where additional writing is necessary.

The position measurement module 30 performs position measurement using the carrier phases measurement values of the plurality of position measurement signals and calculates an accuracy index (S11). The estimation module 40 estimates the convergence prediction time based on the accuracy index (S12).

More specifically, the estimation of the convergence prediction time based on the accuracy index is realized by the following flow illustrated in FIG. 4. FIG. 4 is a flowchart illustrating a first aspect of the estimation of the convergence prediction time based on the accuracy index.

The estimation module 40 acquires the size of the accuracy index (S21). The estimation module 40 estimates the convergence prediction time from the scale of the accuracy index (S22). For example, when the accuracy index decreases as the estimation error decreases, the estimation module 40 estimates the convergence prediction time to be shorter as the accuracy index decreases.

The convergence prediction time can also be estimated by the following method.

FIG. 5 is a flowchart illustrating a second aspect of the estimation of the convergence prediction time based on the accuracy index.

In the second aspect of the estimation of the convergence prediction time illustrated in FIG. 5, the convergence prediction time is estimated based on the change amount of the accuracy index. The change amount of the accuracy index is, for example, a difference of the accuracy index between two times having a predetermined time difference, or a value obtained by dividing the difference by the time difference.

As illustrated in FIG. 2, the temporal change amount of the horizontal error prediction value corresponding to the accuracy index gradually changes from the start of position measurement toward the convergence time of the position measurement. Therefore, the convergence prediction time can be estimated based on the temporal change amount of the accuracy index.

The estimation module 40 calculates the amount of change in the accuracy index (S31). The estimation module 40 estimates the convergence prediction time from the change amount of the accuracy index (S32). For example, when the change amount of the accuracy index decreases as the estimation error decreases, the estimation module 40 estimates the convergence prediction time to be shorter as the change amount of the accuracy index decreases.

FIG. 6 is a flowchart illustrating a third aspect of the estimation of the convergence prediction time based on the accuracy index.

In the third aspect of the estimation of the convergence prediction time illustrated in FIG. 6, the convergence prediction time is estimated based on the standard deviation of the accuracy index. The standard deviation of the accuracy index is calculated, for example, using the accuracy index for a plurality of times within a predetermined time.

As described above, the position measurement is gradually stabilized, and the error of the position measurement decreases as the position measurement approaches convergence. Therefore, as the position measurement approaches convergence, the variation in the accuracy index tends to decrease. Therefore, the convergence prediction time can be estimated based on the variation of the accuracy index. As an example of the value indicating the specific variation, the convergence prediction time can be estimated based on the standard deviation of the accuracy index.

The estimation module 40 calculates the standard deviation of the accuracy index (S41). The estimation module 40 estimates the convergence prediction time from the standard deviation of the accuracy index (S42). For example, when the standard deviation of the accuracy index decreases as the estimation error decreases, the estimation module 40 estimates the convergence prediction time to be shorter as the standard deviation of the accuracy index decreases.

In this process, the standard deviation is used as the value indicating the variation. However, it is also possible to use another value indicating the variation of the accuracy index, for example, variance or the like.

By using the second mode illustrated in FIG. 5 and the third mode illustrated in FIG. 6, the convergence prediction time can be estimated without being affected by the absolute size of the accuracy index. For example, it is conceivable that the accuracy index does not become smaller than the predetermined value even after convergence of the position measurement depending on the position of the positioning satellite that transmits the position measurement signal. Even in such a case, the estimation module 40 can accurately estimate the convergence prediction time by adopting the change amount or the variation.

In addition, in the above description, an aspect in which the error covariance matrix is used as the accuracy index has been described. However, the accuracy index changes as the position measurement approaches convergence, and other physical quantities may be used as long as the time until convergence and the accuracy index have a one-to-one relationship.

In the first aspect, the second aspect, and the third aspect, the convergence prediction time is based on the value indicating the scale, the change amount, and the variation of the accuracy index, respectively. However, the present disclosure is not limited thereto, and the convergence prediction time may be determined by a combination of the scale, the change amount, and the value indicating the variation of the accuracy index. For example, the convergence prediction time may be calculated from the scale of the accuracy index, and the calculated convergence prediction time may be corrected using the value indicating the variation.

Further, for example, the position information itself can be used as the accuracy index. For example, in the case of a stationary point, a value indicating the amount of change and variation in position can be used as it is as an accuracy index. That is, when the value indicating the amount of change or the variation of the position is small, it is considered that the position is converged near the correct position, and thus this can be used.

### Terminology

It is to be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages as may be taught or suggested herein.

All of the processes described herein may be embodied in, and fully automated via, software code modules executed by a computing system that includes one or more computers or processors. The code modules may be stored in any type of non-transitory computer-readable medium or other computer storage device. Some or all the methods may be embodied in specialized computer hardware.

Many other variations than those described herein will be apparent from this disclosure. For example, depending on the embodiment, certain acts, events, or functions of any of the algorithms described herein can be performed in a different sequence, can be added, merged, or left out altogether (e.g., not all described acts or events are necessary for the practice of the algorithms). Moreover, in certain embodiments, acts or events can be performed concurrently, e.g., through multi-threaded processing, interrupt processing, or multiple processors or processor cores or on other parallel architectures, rather than sequentially. In addition, different tasks or processes can be performed by different machines and/or computing systems that can function together.

The various illustrative logical blocks and modules described in connection with the embodiments disclosed herein can be implemented or performed by a machine, such as a processor. A processor can be a microprocessor, but in the alternative, the processor can be a controller, microcontroller, or state machine, combinations of the same, or the like. A processor can include electrical circuitry configured to process computer-executable instructions. In another embodiment, a processor includes an application specific integrated circuit (ASIC), a field programmable gate array (FPGA) or other programmable device that performs logic operations without processing computer-executable instructions. A processor can also be implemented as a combination of computing devices, e.g., a combination of a digital signal processor (DSP) and a microprocessor, a plurality of microprocessors, one or more microprocessors in conjunction with a DSP core, or any other such configuration. Although described herein primarily with respect to digital technology, a processor may also include primarily analog components. For example, some or all of the signal processing algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

Conditional language such as, among others, “can,” “could,” “might” or “may,” unless specifically stated otherwise, are otherwise understood within the context as used in general to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Any process descriptions, elements or blocks in the flow diagrams described herein and/or depicted in the attached figures should be understood as potentially representing modules, segments, or portions of code which include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C. The same holds true for the use of definite articles used to introduce embodiment recitations. In addition, even if a specific number of an introduced embodiment recitation is explicitly recited, those skilled in the art will recognize that such recitation should typically be interpreted to mean at least the recited number (e.g., the bare recitation of “two recitations,” without other modifiers, typically means at least two recitations, or two or more recitations).

It will be understood by those within the art that, in general, terms used herein, are generally intended as “open” terms (e.g., the term “including” should be interpreted as “including but not limited to,” the term “having” should be interpreted as “having at least,” the term “includes” should be interpreted as “includes but is not limited to,” etc.).

For expository purposes, the term “horizontal” as used herein is defined as a plane parallel to the plane or surface of the floor of the area in which the system being described is used or the method being described is performed, regardless of its orientation. The term “floor” can be interchanged with the term “ground” or “water surface.” The term “vertical” refers to a direction perpendicular to the horizontal as just defined. Terms such as “above,” “below,” “bottom,” “top,” “side,” “higher,” “lower,” “upper,” “over,” and “under,” are defined with respect to the horizontal plane.

As used herein, the terms “attached,” “connected,” “mated” and other such relational terms should be construed, unless otherwise noted, to include removable, moveable, fixed, adjustable, and/or releasable connections or attachments. The connections/attachments can include direct connections and/or connections having intermediate structure between the two components discussed.

Numbers preceded by a term such as “approximately,” “about,” and “substantially” as used herein include the recited numbers, and also represent an amount close to the stated amount that still performs a desired function or achieves a desired result. For example, the terms “approximately,” “about,” and “substantially” may refer to an amount that is within less than 10% of the stated amount. Features of embodiments disclosed herein preceded by a term such as “approximately,” “about,” and “substantially” as used herein represent the feature with some variability that still performs a desired function or achieves a desired result for that feature.

It should be emphasized that many variations and modifications may be made to the above-described embodiments, the elements of which are to be understood as being among other acceptable examples. All such modifications and variations are intended to be included herein within the scope of this disclosure and protected by the following claims.

What is claimed is:

1. A positioning device comprising:
processing circuitry configured to:
perform position measurement using carrier phases of a plurality of position measurement signals to calculate a position measurement result and an accuracy index of the position measurement result;
estimate a predicted convergence time of the position measurement based on the accuracy index.

2. The positioning device according to claim 1, wherein
the processing circuitry is further configured:
to estimate the convergence prediction time based on a scale of the accuracy index.

3. The positioning device according to claim 2, wherein
the processing circuitry is further configured:
to estimate the convergence prediction time to be shorter as the accuracy index becomes smaller.

4. The positioning device according to claim 1, wherein
the processing circuitry is further configured:
to estimate the convergence prediction time based on a temporal change of the accuracy index.

5. The positioning device according to claim 4, wherein
the processing circuitry is further configured:
to estimate the convergence prediction time to be shorter as the temporal change amount of the accuracy index is smaller.

6. The positioning device according to claim 1, wherein
the processing circuitry is further configured:
to estimate the convergence prediction time based on a value indicating a variation in the accuracy index within a predetermined time.

7. The positioning device according to claim 6, wherein
the processing circuitry is further configured:
to estimate the convergence prediction time to be shorter as the value indicating the variation of the accuracy index becomes smaller.

8. The positioning device according to claim 1, wherein
the processing circuitry is further configured:
to perform the position measurement by a state estimation equation, wherein:
the position of the positioning device, a clock error, and a carrier ambiguity are estimation values; and
carrier phases of the plurality of position measurement signals is an observation value; and
the processing circuitry is further configured:
to use the error variance of the state estimation equation as the accuracy index.

9. A positioning method comprising:
performing position measurement using carrier phases of a plurality of position measurement signals to calculate a position measurement result and an accuracy index of the position measurement result;
estimating a predicted convergence time of the position measurement based on the accuracy index.

10. The positioning method according to claim 9, further comprising:
performing the position measurement by a state estimation equation, wherein:
the position of the positioning device, a clock error, and a carrier ambiguity are estimation values; and
the carrier phases of the plurality of position measurement signals is an observation value; and
using the error variance of the state estimation equation as the accuracy index.

11. A non-transitory computer-readable storage medium having stored thereon machine-readable instructions that, when executed by one or more processors of an apparatus, cause the apparatus to perform a method comprising:
performing position measurement using carrier phases of a plurality of position measurement signals to calculate a position measurement result and an accuracy index of the position measurement result;
estimating a predicted convergence time of the position measurement based on the accuracy index.

12. The non-transitory computer-readable storage medium according to claim 11, further comprising:
performing the position measurement by a state estimation equation, wherein:
the position of the positioning device, a clock error, and a carrier ambiguity are estimation values; and
carrier phases of the plurality of position measurement signals are an observation value; and
using the error variance of the state estimation equation as the accuracy index.

13. The positioning device according to claim 2, wherein
the processing circuitry is further configured:
to perform the position measurement by a state estimation equation, wherein:
the position of the positioning device, a clock error, and a carrier ambiguity are estimation values; and
carrier phases of the plurality of position measurement signals is an observation value; and
the processing circuitry is further configured:
to use the error variance of the state estimation equation as the accuracy index.

14. The positioning device according to claim 3, wherein
the processing circuitry is further configured:
to perform the position measurement by a state estimation equation, wherein:
the position of the positioning device, a clock error, and a carrier ambiguity are estimation values; and
carrier phases of the plurality of position measurement signals is an observation value; and
the processing circuitry is further configured:
to use the error variance of the state estimation equation as the accuracy index.

15. The positioning device according to claim 4, wherein
the processing circuitry is further configured:
to perform the position measurement by a state estimation equation, wherein:
the position of the positioning device, a clock error, and a carrier ambiguity are estimation values; and
carrier phases of the plurality of position measurement signals is an observation value; and
the processing circuitry is further configured:
to use the error variance of the state estimation equation as the accuracy index.

16. The positioning device according to claim 5, wherein
the processing circuitry is further configured:
to perform the position measurement by a state estimation equation, wherein:
the position of the positioning device, a clock error, and a carrier ambiguity are estimation values; and
carrier phases of the plurality of position measurement signals is an observation value; and
the processing circuitry is further configured:
to use the error variance of the state estimation equation as the accuracy index.

17. The positioning device according to claim 6, wherein
the processing circuitry is further configured:
to perform the position measurement by a state estimation equation, wherein:
the position of the positioning device, a clock error, and a carrier ambiguity are estimation values; and
carrier phases of the plurality of position measurement signals is an observation value; and
the processing circuitry is further configured:
to use the error variance of the state estimation equation as the accuracy index.

18. The positioning device according to claim 7, wherein
the processing circuitry is further configured:
to perform the position measurement by a state estimation equation, wherein:
the position of the positioning device, a clock error, and a carrier ambiguity are estimation values; and
carrier phases of the plurality of position measurement signals is an observation value; and
the processing circuitry is further configured:
to use the error variance of the state estimation equation as the accuracy index.
